(19) United States
(12) Patent Application Publication
(10) Pub. No.: US 2006/0123848 A1
(43) Pub. Date: Jun. 15, 2006

(54) Method for observing a glass and controlling heating effect in a hardening oven for a glass sheet

(76) Inventor: Petri Lammi, Kyroskoski (FI)

Correspondence Address: STITES & HARBISON PLLC, 1199 NORTH FAIRFAX STREET, SUITE 900, ALEXANDRIA, VA, 22314, US

(21) Appl. No.: 10/560,349

(22) PCT Filed: Jun. 10, 2004
(86) PCT No.: PCT/FI04/00355

§ 371 Date: Dec. 12, 2005

(30) Foreign Application Priority Data
Jun. 11, 2003 (FI) 20030875

(51) Int. Cl. C03B 27/00

(52) U.S. Cl. 65/29.19; 65/29.11

(57) ABSTRACT

A method to observe glass (1) and to regulate the heating effect of heating elements (5) in a sheet glass hardening furnace, which furnace comprises a glass heating sector, a transportation rail (3) to transport glass (1) to and from the said heating section and said heating elements (5) to heat the glass by means of radiation and air blast, and a furnace control system to carry out the hardening process of glass (1). The location area in the furnace of one or several glass sheets (1), watched from the glass sheet level, is observed with measuring instruments (6), by means of which air temperatures in the heating section above glass (1) transportation rail (3) is measured and the heating effect of their heating elements (5) raised by regulation, at which the location of glass sheet (1) is observed by means of the method.

The invention relates to a method to observe the glass and to regulate the heating effect of heating elements in a sheet glass hardening furnace, which furnace comprises a glass heating section, a transportation rail to transport the glass to and from the said heating section and said heating elements to heat the glass by means of radiation and air blast, and a furnace control system to carry out the hardening process of the glass.

Previously known is from the Finnish patent publication FI-106256 focusing the heating on the glass sheet in a hardening furnace, when the loading pattern of glass sheets approaching the furnace has been read in advance, for instance from the loading table or in moving them to the furnace, the loading pattern is read the memory of the control system. On basis of the loading pattern additional heating is regulated to the centre of the glass sheets.

The disadvantage of such an arrangement is that it ought to be possible by means of the read loading pattern to distribute the heating air blast properly from the nozzles to areas, where there is glass surface. This is difficult, that is why the solution of the above mentioned publication has additional heating with radiation heaters by means of which radiation is conducted controllably to the centre of glass sheets. The disadvantage of the solution is the need of additional heaters and separate controls they need.

By means of the method according to the invention the reading of the loading pattern going to and being in the furnace is solved and, furthermore, focusing the heating on the glass sheets can be corrected even during heating without any additional heaters. The method according to the invention is characterized in that the location area in the furnace of one or several glass sheets watched from the glass sheet level is observed by means of temperature measuring equipment by means of which air temperatures in the heating section above the glass transportation rail and the effect of the heating elements is strongly regulated, at which elements the location of the glass sheet is observed by means of the method.

The advantage as per the method of the invention is that the location pattern of the glass sheets can be read with sufficient accuracy in the simple way introduced by the invention, whereby the effect of the heating elements can be regulated and focused to the glass sheet location areas. When the glass sheet location and existence in the furnace is measured by means of measured temperatures all the time during measuring it is possible even to change the impact of heating on different areas so that all glass sheets would at the same time be at hardening temperature or all spots of a bigger glass sheet would reach the hardening temperature at the same time.

In the following the invention disclosed with reference to the enclosed drawing, where

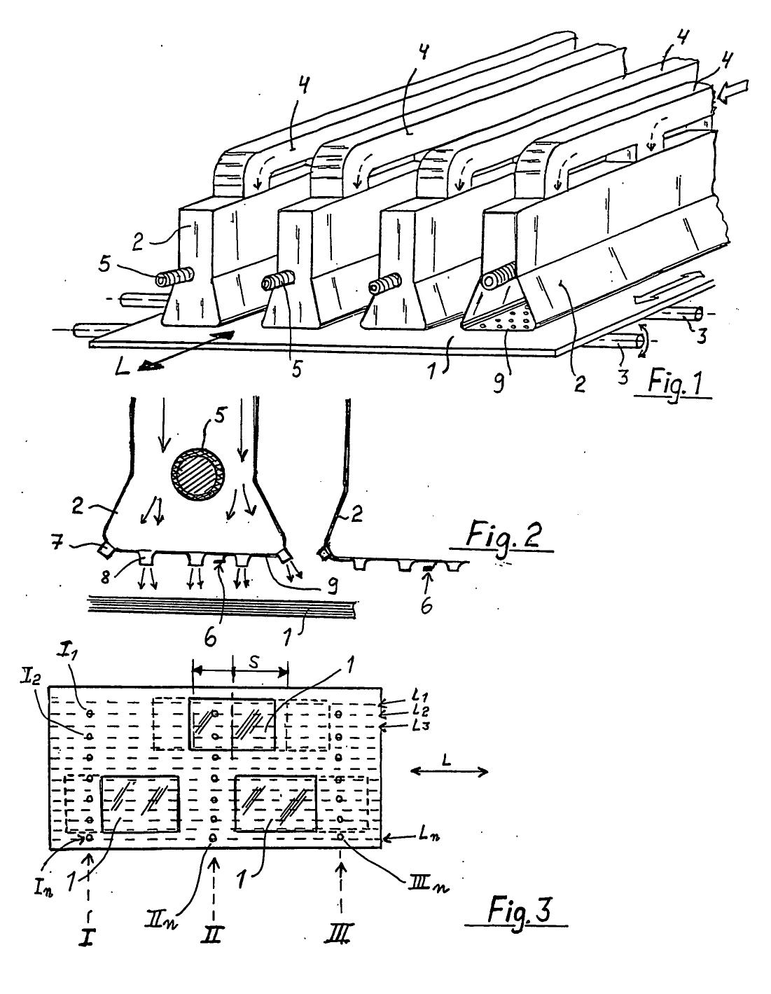

FIG. 1 shows a fractional part of the hardening furnace seen diagonally.

FIG. 2 shows hot air blast channels seen from the end.

FIG. 3 shows heating lines and glass sheets in the furnace seen from above.

In FIG. 1 a part of the glass tempering furnace is shown, which furnace comprises walls (not shown) and a transportation rail formed of rotating rolls 3, on which glass sheet 1 is movable in a way wanted during and after the process. In order to convey blast air to glass 1 surface the furnace has oblong channels 2, which in this example are fitted in glass 1 direction L. To channels 2 blast air is brought from one or several blowers along distribution channels 4. Into channels 2 heating elements 5 the direction of channels 2 are placed. Channels 2 widen downward under heating elements 5 and get into bottom parts which have holes. At least bottom part 9 is of thin plate with openings 7, 8 punched in it, most suitably so that also collars downward around the holes have been made (FIG. 2) with the punching tool.

In channels 2 heating elements 5 are in relatively strong air blast and the air blast runs close pass elements 5. At the resistance the blast air runs heated through bottom part 9 openings towards glass 1. Thanks to the widened bottom part 9 the coverage of blast holes 8 on the glass surface becomes large. Between channels 2 a sufficient space remains for the return of air to the suction face of the blower.

In FIG. 2 the fitting situation of channels 2 is shown directly from their end. The distance between bottom part 9 and glass 1 is adjusted to about 50-70 mm. In the immediate vicinity of bottom part 9, however not touching it, detectors 6 are fitted to measure the air temperature between bottom part 9 and the glass or the air temperature between bottom part 9 and the transportation rail, if there is no glass at that place. The detector is placed about 10-50 mm above the glass/rail.

When the furnace is in continuous use, its airspace is hundreds of C grades all the time. Transportation rail 3 is also hot all the time. On bringing glass sheet 1 or several glass sheets to the furnace, the temperature detector 6 above the glass reacts at once to the existence of cold glass. A detector 6 that has under it only one transportation roll does hardly react to temperature change, when glass sheets are approaching the furnace. Placing a sufficient number of temperature detectors 6 above the transportation rail a reliable pattern is received from their indications where in the furnace there is glass surface or not.

FIG. 3 shows a positioning of detectors 6 in lines L1-Ln. In the figure in each of them three detectors 6 per line are shown. The directions of lines L are the same as the directions of heating elements 5 and also the directions of the glass are the same and the oscillation directions, too. The number of lines L, which have detectors 6, can be the same as the number of channels 2 or less.

In one embodiment the average temperature is calculated from the indications of each line L1-Ln of detectors L_{I}, L_{II} and L_{III}, which average is used at them by the control system for estimation of the size of the glass surface below. If there is glass surface under all three detectors 6 even all the time during the oscillation travel, there is on line L the lowest temperature average.

The less glass surface under detectors 6 of some line L the higher the average temperature. The control system is programmed to regulate the heating elements of each line L on basis of the average temperatures. The special advantage of the invention appears in that the information of temperature sent by the detectors is received all the time during the heating cycle. Then, if necessary, the control system is programmed to correct the distribution of the heating effect during heating, if the temperatures averages do not rise in the way set. For instance if needed, the effects of the heating elements in the directions of lines L are changed by means of fry control so that glass sheets 1 would reach hardening temperature at the same time. When detectors 6 are very close to the glass surface, the impact of a glass little colder than another glass in the furnace gets till detector 6 as different in spite of that there is strong flow of hot blast air from beside detector 6 to the glass. The air flow hits the glass, cools a little and the return flow or part of it that has hit the glass hits detector 6, whereby from the detector lower temperature information is received than from the other detector. When there is still from all detectors 6 direct radiation connection to glass 1, the different temperatures of glass sheets will also influence the detectors differently due to different radiation effects. On basis of data from the detectors it is possible to distinguish temperature differences under 20° C. among glass surfaces.

On line L several detectors 6 can be placed. When glass sheets 1 make oscillation, distance s FIG. 3, there may be glass surface at detectors 6 all the time. Then all detectors remain in low temperatures. If during oscillation the glass sheet moves a little at one detector, it has an immediate, temperature-increasing effect on the detector. The average glass load of each line L can be found out from the separate temperatures of the detectors or also even from their calculated average. If heating elements 5 are uniform in length of the furnace in line L direction, they can be regulated on basis of the temperature average of line L.

In one embodiment there can be in line L direction heating elements, many ones controlled separately one after another, whereby each element is has a counter detector 6 placed fairly under it. Then by means of the separate regulation the heating can be focused on the glass still more accurately, using the temperature data received from the detector.

1. A method to observe glass (1) and to regulate the heating effect of heating elements (5) in a sheet glass hardening furnace, which furnace comprises a glass heating sector, a transportation rail (3) to transport glass (1) to and from the said heating section and said heating elements (5) to heat the glass by means of radiation and air blast, and a furnace control system to carry out the hardening process of glass (1), characterized in that the location area in the furnace of one or several glass sheets (1), watched from the glass sheet level, is observed with measuring instruments (6), by means of which air temperatures in the heating section above glass (1) transportation rail (3) is measured and the heating effect of their heating elements (5) raised by regulation, at which the location of glass sheet (1) is observed by means of the method.

2. A method according to claim 1 characterized in that detectors (6) of the temperature measuring instruments are located in the furnace one after another essentially in the course L direction of glass (1).

3. A method according to claim 1 characterized in that there are several detectors (6) side by side in the direction of the lines (L1-Ln) of glass (1) course.

4. A method according to claim 1 characterized in that there are detectors (6) at least three one after another in the same line (L).

5. A method according to claim 1 characterized in that (6) are located about 10-50 mm above glass/rail (3).

6. A method according to claim 1 characterized in that as temperature reading of each line L the average is calculated from the reading of all detectors ( L_{I}, L_{II}, L_{M}) of the line.

7. A method according to claim 1 characterized in that from the temperature average of each (line) (L) the glass load is concluded.

8. A method according to claim 1 characterized in that temperature averages are calculated during the heating cycle and the effect of heating elements of a preferred line L is regulated depending on the temperature average calculated during heating.

9. A method according to claim 1 characterized in that the temperature-measuring detectors (6) are placed above rail (3) essentially to measure the air temperature and to free radiation contact down onto the glass/rail (3).
